(19) United States
(12) Patent Application Publication
(10) Pub. No.: US 2021/0110331 A1
(43) Pub. Date: Apr. 15, 2021

(54) Method and System for Quantifying Workforce Transformation of an Organization

(71) Applicant: Radhika Chavan, Pune (IN)

(72) Inventor: Radhika Chavan, Pune (IN)

(21) Appl. No.: 16/720,088

(22) Filed: Dec. 19, 2019

(30) Foreign Application Priority Data
Oct. 11, 2019 (IN) 201921041221

(51) Int. Cl. G06Q 10/06

(52) U.S. Cl. CPC G06Q 10/063112; G06Q 10/063118

(57) ABSTRACT

A system for quantifying workforce transformation of an organization includes a server that determines current skills of each individual of the organization. The server determines a first score for the organization based on the current skills to classify the organization into a first level of digital awareness of a plurality of levels of digital awareness. The server predicts based on the first level of digital awareness and the current skills, a skill gap, a learning rate, and future skills for each individual, and recommends a training plan for each individual to acquire the future skills. The server assesses the training plan periodically, to determine a second score for the organization, and classifies based on the second score, the organization into a second level of digital awareness of the plurality of levels of digital awareness, thereby quantifying the workforce transformation of the organization.

### CROSS-RELATED APPLICATIONS

This application claims priority of Indian Application Serial No. 201921041221, filed Oct. 11, 2019, the contents of which are incorporated herein by reference.

### FIELD OF THE DISCLOSURE

Various embodiments of the disclosure relate generally to workforce transformation of organizations. More specifically, various embodiments of the disclosure relate to a method and a system for quantifying workforce transformation of an organization.

### DESCRIPTION OF THE RELATED ART

To achieve digital transformation in organizations due to continual and a directional advancement of digital technologies, the organizations determine and analyze a current status of digital awareness of the organization. The current status of digital awareness indicates an ability and an inclination of the organization to utilize emerging digital technologies for achieving the digital transformation. Based on the current status of digital awareness, the organization identifies a gap between current technologies and processes within the organization and emerging digital technologies and processes. The organizations define roadmaps for achieving desired digital awareness for utilizing the emerging digital technologies and processes.

Digital transformation of an organization is dependent on various elements of the organization. One such element is workforce transformation of the organization that focuses on transforming individuals (or workforce) of the organization to adapt to new digital technologies and learn new skills. A known method for achieving workforce transformation of the organization includes training of the individuals of the organization, and upskilling the individuals as current skills of the workforce may become obsolete due to emerging technologies. However, the known method fails to provide metrics associated with the individuals and future skills required by the individuals to quantify the workforce transformation and hence analyze a status of digital awareness of the organization accurately.

Thus, it would be advantageous to have a method and a system for quantifying the workforce transformation of an organization based on a current status of digital awareness and desired business outcomes of the organization.

### SUMMARY

In an embodiment, the disclosure provides a system for quantifying workforce transformation of an organization. The system includes a server that is configured to determine based on a set of current skills associated with each individual of a set of individuals of the organization, a first score for the organization, and classify based on the first score, the organization into a first level of digital awareness of a plurality of levels of digital awareness. The server is further configured to predict based on the first level of digital awareness and the set of current skills, a skill gap, a learning rate, and a set of future skills for each individual, and recommend based on the predicted learning rate and the predicted set of future skills, a training plan for each individual. The server is further configured to assess the training plan of each individual periodically, to determine a second score for the organization, and classify based on the second score, the organization into a second level of digital awareness of the plurality of levels of digital awareness, thereby quantifying the workforce transformation of the organization.

In another embodiment, the disclosure provides a method for quantifying workforce transformation of an organization. The method includes determining, by a server based on a set of current skills associated with each individual of a set of individuals of the organization, a first score for the organization, and classifying, by the server based on the first score, the organization into a first level of digital awareness of a plurality of levels of digital awareness. The method further includes predicting, by the server based on the first level of digital awareness and the set of current skills, a skill gap, a learning rate, and a set of future skills for each individual, and recommending, by the server based on the predicted learning rate and the predicted set of future skills, a training plan for each individual. The method further includes assessing, by the server, the training plan of each individual periodically, to determine a second score for the organization, and classifying, by the server based on the second score, the organization into a second level of digital awareness of the plurality of levels of digital awareness, thereby quantifying the workforce transformation of the organization.

### BRIEF DESCRIPTION OF DRAWINGS

The following detailed description of the preferred embodiments of the disclosure will be better understood when read in conjunction with the appended drawings. The disclosure is illustrated by way of example, and not limited by the accompanying figures, in which like references indicate similar elements.

FIG. 1 is a block diagram that illustrates an environment for quantifying workforce transformation of an organization in accordance with an embodiment of the disclosure;

FIG. 2 is a block diagram that illustrates an application server of the environment of FIG. 1 in accordance with an embodiment of the disclosure;

FIG. 3 is a block diagram that illustrates a first user interface rendered on a user device of the environment of FIG. 1 in accordance with an embodiment of the disclosure;

FIG. 4 is a block diagram that illustrates a second user interface rendered on a display screen associated with the application server of FIG. 2, in accordance with an embodiment of the disclosure; and

FIGS. 5A and 5B, collectively, represent a flow chart that illustrates a method for quantifying the workforce transformation of the organization in accordance with an embodiment of the disclosure.

### DETAILED DESCRIPTION OF EMBODIMENTS

The detailed description of the appended drawings is intended as a description of the currently preferred embodiments of the disclosure, and is not intended to represent the only form in which the disclosure may be practiced. It is to be understood that the same or equivalent functions may be accomplished by different embodiments that are intended to be encompassed within the spirit and scope of the disclosure.

References to “an embodiment”, “another embodiment”, “yet another embodiment”, “one example”, “another example”, “yet another example”, “for example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in an embodiment” does not necessarily refer to the same embodiment.

Various embodiments of the disclosure provide a system for quantifying workforce transformation of an organization. The system includes a server that processes data associated with each individual of a set of individuals of the organization, to determine a set of current skills associated with each individual. Based on the set of current skills, the server determines a first score for the organization, to classify the organization into a first level of digital awareness of a plurality of levels of digital awareness. A skill gap, a learning rate, and a set of future skills for each individual are predicted by the server based on the first level of digital awareness and the set of current skills, to recommend a training plan for each individual. The server assesses the training plan of each individual periodically, to determine a third score for each individual, and a fourth score and a weightage for each future skill. Based on the fourth score and the weightage for each future skill, the server determines a second score for the organization, and classifies based on the second score, the organization into a second level of digital awareness of the plurality of levels of digital awareness. Thus, the server quantifies the workforce transformation of the organization and tracks the workforce transformation of the organization periodically.

The server determines the first and second scores for the organization and classifies the organization into the first and second levels of digital awareness. Thus, the server utilizes the first and second scores as metrics to quantify the workforce transformation of the organization. Additionally, based on the first and second levels of digital awareness, the server keeps a track of the current status of digital awareness of the organization and predicts roadmaps for further transforming the workforce for achieving desired business outcomes and improving the digital awareness of the organization. Thus, the workforce transformation of the organization is quantified based on the current status of digital awareness and the desired business outcomes.

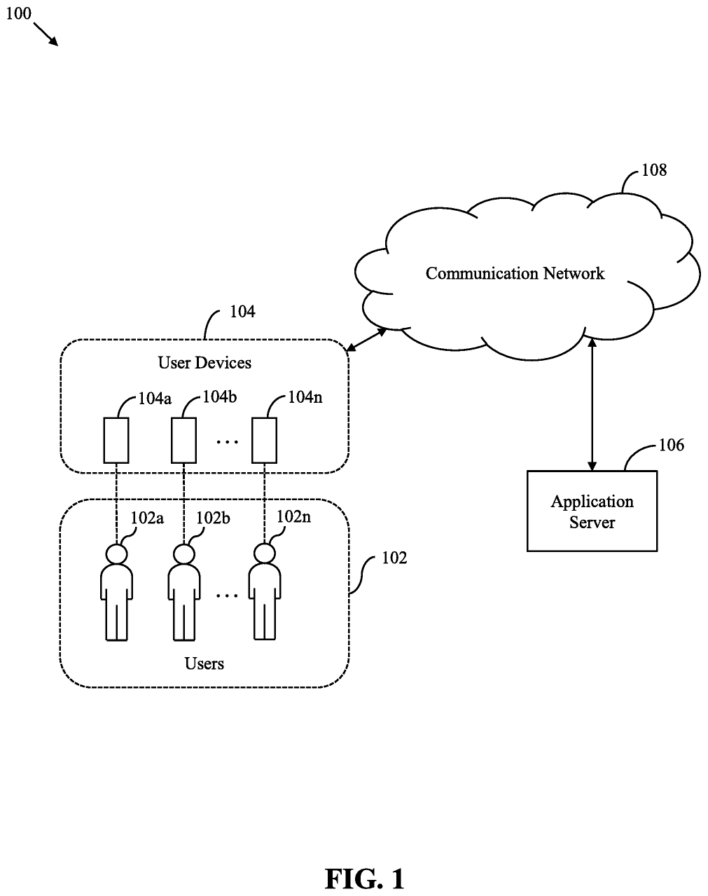

FIG. 1 is a block diagram that illustrates an environment 100 for quantifying digital transformation of an organization, in accordance with an embodiment of the disclosure. The environment 100 includes users 102a-102n (hereinafter designated and referred to as “the users 102”), user devices 104a-104n (hereinafter designated and referred to as “the user devices 104”), and an application server 106. The user devices 104 and the application server 106 may communicate with each other by way of a communication network 108 or through separate communication networks established therebetween.

The users 102 are a set of individuals (i.e., employees or workforce) of an organization, whose data may be utilized by the application server 106 for quantifying workforce transformation of the organization, such as a company, a firm, or an institution. The data of each user, such as the user 102a, of the users 102 may include historic data of the user 102a, interests of the user 102a, and training courses accomplished by the user 102a on various online learning platforms. The historic data of the users 102 may refer to data collected based on past events pertaining to the users 102. For instance, the historic data of the user 102a may include, but is not limited to, curriculum information, education particulars, and employment details of the user 102a. The historic data of the user 102a may further include an activity log (i.e., a number of hours spent) of the user 102a on the Internet and various online learning platforms. The interests of the user 102a may include various technical and non-technical skills that the user 102a has acquired over a period of time. The training courses include audio lectures, video lectures, assessment tests, assignments, and the like, that may be accomplished by the user 102a when the training courses are presented to the user 102a through various online learning platforms (such as, but not limited to, Coursera™ (a trademark of Coursera Inc.), EdX℠ (a service mark of edX Inc.), and Udacity℠ (a service mark of Udacity Inc.), on the user device 104a.

It will be apparent to those of skill in the art that although in the current embodiment the users 102 are employees of the organization, in an alternate embodiment, the users 102 may be job candidates and the organization may hire and train the users 102 for transforming the workforce.

The user devices 104 may include suitable logic, circuitry, interfaces, and/or code, executable by the circuitry, that may be configured to perform one or more operations for providing a set of documents, a set of skill profiles, a set of accomplished trainings, and a set of certifications that are associated with the users 102a-102n, to the application server 106. In one exemplary scenario, the user devices 104 may refer to communication devices of the users 102. The user devices 104 may be configured to allow the users 102 to communicate with the application server 106. The user devices 104 may be configured to serve as an interface for providing information of the users 102 to the application server 106. In an embodiment, the user device 104a may be configured to run or execute a software application (for example, a mobile application or a web application), which may be hosted by the application server 106, for presenting various training courses to the user 102a. The user device 104a may be configured to communicate a status of the training course completion by the user 102a to the application server 106. The user device 104a may be further configured to run or execute the software application for accessing various files stored in a memory (not shown) of the user device 104a.

The user device 104a may be configured to keep a track of the training courses accomplished by the user 102a on the user device 104a, various certifications that the user 102a gained by accomplishing various training courses, or various rewards that the user 102a received within the organization. For example, the user device 104a may be configured to store a training log in the memory of the user device 104a that includes information pertaining to the trainings accomplished by the user 102a on the user device 104a and the certifications, such as academic degrees, skill certificates, and the like, gained by the user 102a. In another example, the user device 104a may be configured to communicate to the application server 106, in real-time, the information pertaining to the training courses accomplished by the user 102a on the user device 104a and the certifications gained by the user 102a. The user device 104a may be further configured to store and communicate to the application server 106, a set of documents (such as marksheets or grade cards) and a skill profile, i.e., a resume, of the user 102a. In an embodiment, the user device 104a may be configured to receive, from the application server 106 via the communication network 108, one or more user interfaces that allow the user 102a to interact and view the one or more user interfaces (one at a time). Examples of the user devices 104 may include, but are not limited to, mobile phones, smartphones, laptops, desktops, tablets, phablets, or other devices capable of communicating via the communication network 108.

The application server 106 may include suitable logic, circuitry, interfaces, and/or code, executable by the circuitry, that may be configured to perform one or more operations for quantifying the workforce transformation. The application server 106 may be a physical or cloud data processing system on which a server program runs. The application server 106 may be implemented in hardware or software, or a combination thereof. The application server 106 may be configured to host the software application which may be accessible on the Internet for providing a quantification of workforce transformation service. The application server 106 may be configured to utilize the software application for extracting the data of the users 102. The application server 106 may be further configured to use a tracker or a web crawler to track the activities of the users 102 on the Internet and the online learning platforms for retrieving the data.

The application server 106 may be configured to extract data associated with each user of the users 102 from the set of documents, the set of skill profiles, the set of accomplished trainings, and the set of certifications that are associated with the corresponding user. The extracted data may include domain of expertise, educational qualifications, a professional experience, a career path, and the like, of the corresponding user. The application server 106 processes the extracted data for each user of the users 102 to determine a set of current skills associated with each user of the users 102. The set of current skills includes skills that a corresponding user of the users 102 have acquired. The application server 106 may be configured to determine based on the set of current skills associated with each user of the users 102, a first score for the organization. The first score of the organization indicates an initial status of digital awareness (i.e., digital maturity or a current ability of the organization to utilize emerging technologies) of the organization. Based on the first score, the application server 106 may be configured to classify the organization into a first level of digital awareness of a plurality of levels of digital awareness. The plurality of levels of digital awareness indicate an ability of the organization to utilize emerging technologies for achieving digital transformation. Based on the first level of digital awareness and the set of current skills, the application server 106 may be configured to predict, a skill gap, a learning rate and a set of future skills for each user of the users 102. The skill gap is a gap between skills required by the organization and the set of current skills. The learning rate indicates a time required by a corresponding user to acquire a new skill. The set of future skills includes skills that a corresponding user of the users 102 are required to acquire for upskilling and achieving workforce transformation of the organization.

The application server 106 may be configured to recommend based on the predicted learning rate and the predicted set of future skills, a training plan for each user of the users 102. The training plan is a detailed schedule of trainings to be completed by the corresponding user for acquiring the set of future skills. The application server 106 may be configured to assess the training plan of each user of the users 102 periodically, to determine a second score for the organization. The second score of the organization indicates a current status of digital awareness of the organization. Based on the second score, the application server 106 may be configured to classify the organization into a second level of digital awareness of the plurality of levels of digital awareness, thereby quantifying the workforce transformation of the organization. The movement of the organization from the first level to the second level of digital awareness indicates a transformation of the workforce. Further, classification of the organization into one of the levels of digital awareness based on a score, such as the second score, facilitates quantification of the workforce transformation and enables tracking of the workforce transformation of the organization.

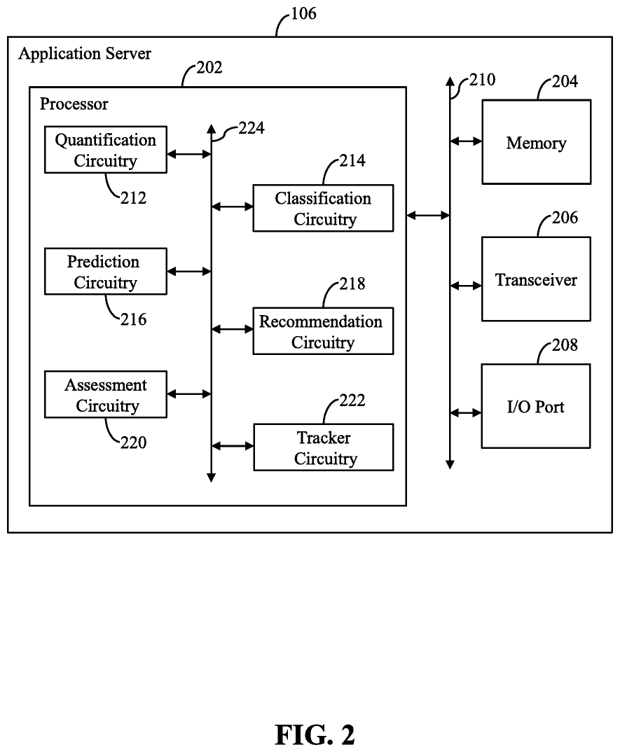

The application server 106 may be realized through various web-based technologies, such as, but not limited to, a Java web-framework, a .NET framework, a PHP framework, or any other web-application framework. Examples of the application server 106 may include, but are not limited to, computers, laptops, mini-computers, mainframe computers, mobile phones, tablets, and any non-transient and tangible machines that may execute a machine-readable code, a cloud-based server, or a network of computer systems. Various functional elements of the application server 106 have been described in detail in conjunction with FIG. 2.

The communication network 108 is a medium through which content and messages are transmitted between the user devices 104 and the application server 106. Examples of the communication network 108 include, but are not limited to, a Wi-Fi network, a light fidelity (Li-Fi) network, a local area network (LAN), a wide area network (WAN), a metropolitan area network (MAN), a satellite network, the Internet, a fiber optic network, a coaxial cable network, an infrared (IR) network, a radio frequency (RF) network, and combinations thereof. Various entities in the environment 100 may connect to the communication network 108 in accordance with various wired and wireless communication protocols, such as Transmission Control Protocol and Internet Protocol (TCP/IP), User Datagram Protocol (UDP), Long Term Evolution (LTE) communication protocols, or any combination thereof.

FIG. 2 is a block diagram that illustrates the application server 106, in accordance with an embodiment of the disclosure. The application server 106 may include a processor 202, a memory 204, a transceiver 206, an input/output (I/O) port 208. The processor 202, the memory 204, the transceiver 206, and the I/O port 208 may communicate with each other by means of a first communication bus 210.

The processor 202 may include suitable logic, circuitry, interfaces, and/or code, executable by the circuitry, that may be configured to perform one or more operations for quantifying the workforce transformation in the organization. The processor 202 may be configured to obtain and store the set of documents, the set of skill profiles, the set of accomplished trainings, and the set of certifications that are associated with the users 102 in the memory 204. The processor 202 may be configured to extract the data of each user of the users 102 and process the extracted data associated with the users 102 to determine a set of current skills of each user of the users 102. In an example, the processor 202 extracts and processes data associated with the user 102a to determine the set of current skills, such as statistics, data visualization, and the like, of the user 102a. Examples of the current skills may include, but are not limited to, technical skills, such as ‘Statistics’, ‘Big Data’, ‘C++’, ‘Python’, and the like, and soft skills, such as ‘Verbal Communication’, ‘Written communication’, and the like. For example, the processor 202 may be configured to control and manage various functionalities and operations of the application server 106 such as quantification, classification, prediction, recommendation, assessment, and tracking. The various functionalities and operations may be controlled and managed by means of one or more internal components of the processor 202, such as a quantification circuitry 212, a classification circuitry 214, a prediction circuitry 216, a recommendation circuitry 218, an assessment circuitry 220, and a tracker circuitry 222, that communicate with each other by way of a second communication bus 224. Examples of the processor 202 may include, but are not limited to, an application-specific integrated circuit (ASIC) processor, a reduced instruction set computing (RISC) processor, a complex instruction set computing (CISC) processor, a field-programmable gate array (FPGA), and the like.

The memory 204 may include suitable logic, circuitry, interfaces, and/or code, executable by the circuitry, that may be configured to store the instructions and/or code that enable the processor 202 to execute the operations. In an embodiment, the memory 204 stores the set of documents, the set of skill profiles, the set of accomplished trainings, and the set of certifications that are associated with the users 102. The memory 204 may be further configured to store the data associated with the users 102. Examples of the memory 204 may include, but are not limited to, a random-access memory (RAM), a read-only memory (ROM), a removable storage drive, a hard disk drive (HDD), a flash memory, a solid-state memory, and the like. It will be apparent to a person skilled in the art that the scope of the disclosure is not limited to realizing the memory 204 in the application server 106, as described herein. In another embodiment, the memory 204 may be realized in form of a cloud storage (not shown) or a database server (not shown) working in conjunction with the application server 106, without departing from the scope of the disclosure.

The transceiver 206 may include suitable logic, circuitry, interfaces, and/or code, executable by the circuitry, that may be configured to transmit (or receive) data to (or from) various entities, such as the user devices 104 over the communication network 108. Examples of the transceiver 206 may include, but are not limited to, an antenna, a radio frequency transceiver, a wireless transceiver, a Bluetooth transceiver, an Ethernet port, a universal serial bus (USB) port, or any other device configured to transmit and receive data. The transceiver 206 may be configured to communicate with the user devices 104 using various wired and wireless communication protocols, such as TCP/IP, UDP, LTE communication protocols, or any combination thereof.

The I/O port 208 may include suitable logic, circuitry, interfaces, and/or code, executable by the circuitry, that may be configured to connect the application server 106 to external devices (not shown). The I/O port 208 may include various input and output devices that are configured to communicate with the processor 202. Examples of the input devices may include a keyboard, a mouse, a joystick, a touchscreen, a microphone, and the like. Examples of the output devices may include a display screen, a speaker, headphones, and the like.

The quantification circuitry 212 may include suitable logic, circuitry, interfaces, and/or code, executable by the circuitry, that may be configured to perform the one or more operations for generating various scores for quantifying the workforce transformation of the organization. The quantification of the workforce transformation is indicative of determining metrics for assessing a status of the organization in terms of digital awareness. In an embodiment, the quantification circuitry 212 may be configured to extract the data of the users 102 from the set of documents, the set of skill profiles, the set of accomplished trainings, and the set of certifications that are associated with the users 102. The quantification circuitry 212 may be further configured to process the extracted data to determine the set of current skills for each user by utilizing an artificial intelligence (AI) model. The AI model is implemented based on deep learning algorithms, natural language processing algorithms, and the like. In an embodiment, the quantification circuitry 212 determines six metrics, such as a communication metric (C1), a confidence metric (C2), a capability metric (C3), a curiosity metric (C4), a creativity metric (C5), and a character metric (C6), for each user of the users 102 based on the processing of the data associated with the users 102. C1 indicates a numerical value for communication skills of the corresponding user. C2 indicates a numerical value for a confidence level of the corresponding user. C3 indicates a numerical value for capability of the corresponding user to learn new skills. C4 indicates a numerical value for curiosity of the corresponding user to learn about various technical domains. C5 indicates a numerical value for a creativity level of the corresponding user. C6 indicates a numerical value for moral character of the corresponding user. The six metrics C1-C6 thus correspond to numerical values (for example, values between ‘0’ and ‘1’) for corresponding soft skills acquired by the users 102. Further, the values of the six metrics C2-C6 may be determined periodically. Based on the set of current skills and the values of the six metrics C1-C6 associated with each user of the users 102, the quantification circuitry 212 determines the first score for the organization. In an embodiment, the first score is a normalized score and has a value between ‘0’ and ‘1’. The first score is a metric to analyze the initial status of digital awareness of the organization.

The classification circuitry 214 may include suitable logic, circuitry, interfaces, and/or code, executable by the circuitry, that may be configured to perform the one or more operations for classifying the users 102 and the organization into one of the plurality of levels of digital awareness. In an embodiment, the plurality of levels include a digitally nascent level, a digitally informed level, a digitally competent level, and a digitally proficient level. The classification circuitry 214 may be configured to classify each user of the users 102 into one of the plurality of levels of digital awareness based on the six metrics C1-C6 and the set of current skills of the corresponding user. In an example, the classification circuitry 214 classifies the user 102a into the digitally nascent level, if a value of C1 is between ‘0.5’ to ‘0.7’, a value of C2 is between ‘0.5’ to ‘1’, a value of each of C3-C5 is ‘0.5’, and a value of C6 is between ‘0.5’ to ‘0.7’. The classification circuitry 214 classifies the user 102a into the digitally informed level, if a value of C1 is between ‘0.6’ to ‘0.8’, a value of C2 is between ‘0.7’ to ‘1’, a value of each of C3 and C4 is between ‘0.6’ to ‘0.7’, a value of C5 is ‘0.6’, and a value of C6 is ‘0.8’. The classification circuitry 214 classifies the user 102a into the digitally competent level, if a value of each of C1 and C2 is between ‘0.8’ to ‘0.9’, a value of each of C3-C5 is between ‘0.7’ to ‘0.9’, and a value of C6 is ‘0.9’. The classification circuitry 214 classifies the user 102a into the digitally proficient level, if a value of each of C1-C5 is between ‘0.9’ to ‘1’ and a value of C6 is ‘1’. In the example, for the user 102a, the value of each of C1-C4 is ‘0.8’ and a value of each of C5 and C6 is ‘0.9’, thus the classification circuitry 214 classifies the user 102a into the digitally competent level.

The classification circuitry 214 may be configured to classify the organization into the first level of digital awareness of the plurality of levels of digital awareness based on the first score. In an embodiment, if the first score is greater than ‘0’ and less than ‘0.1’, the first level of digital awareness is a digitally nascent level, and if the first score is greater than or equal to ‘0.1’ and less than ‘0.4’, the first level of digital awareness is a digitally informed level. If the first score is greater than or equal to ‘0.4’ and less than ‘0.7’, the first level of digital awareness is a digitally competent level, and if the first score is greater than or equal to ‘0.7’ and less than or equal to ‘1’ the first level of digital awareness is a digitally proficient level. In an example, the first score for the organization is ‘0.5’, thus the classification circuitry 214 classifies the organization into the first digital level, i.e., the digitally competent level. It will be apparent to those of skill in the art that the classification circuitry 214 may be further configured to classify each user of the users 102 into one of the plurality of levels of digital awareness based on the six metrics C1-C6 and the set of current skills of the corresponding user in a manner similar to the classification of the organization.

The prediction circuitry 216 may include suitable logic, circuitry, interfaces, and/or code, executable by the circuitry, that may be configured to perform the one or more operations for predicting skill gaps, learning rates, and future skills for the users 102. In an embodiment, the prediction circuitry 216 may be configured to utilize the AI model to predict a skill gap, a learning rate, and a set of future skills for the user 102a. The skill gap, the learning rate, and the set of future skills of each user of the users 102 are predicted based on the first level of digital awareness and the set of current skills of each user of the users 102. The skill gap for the user 102a indicates a gap between the set of current skills of the user 102a and the set of future skills predicted for the user 102a. In an embodiment, the skill gap of each user is further predicted based on the values of the six metrics C1-C6 for each user of the users 102. In an example, a skill gap for the user indicates one or more skills (i.e., a gap between the set of current skills and the skills required by the organization), such as ‘Advanced Statistics’, that the user 102a is lacking and needs to acquire. In another example, a skill gap may indicate an improvement required in the soft skills corresponding to the six metrics C1-C6 for upskilling the corresponding user.

The learning rate may be ‘low’, ‘average’, and ‘high’ based on a time required by a user, such as the user 102a, to learn a new skill. In an embodiment, a learning rate for the user 102a is determined based on the historic data of the user 102a, such as a time duration required for accomplishing previous training courses. For example, if the user 102a required ‘4 hours’ to complete ‘Introduction to Statistics’ training course which had a course duration of ‘6 hours’, the learning rate is ‘high’ for the user 102a as the user 102a completed the training course in less time as compared to the course duration. The set of future skills includes skills to be acquired by the user 102a for upskilling. In an embodiment, a set of future skills for the user 102a is determined based on the current skills of the user 102a and new skills required by the organization. In an example, the prediction circuitry 216 predicts the learning rate as ‘average’ and the set of future skills, such as ‘Big Data’, ‘Python’, and the like, for the user 102a. Each future skill is associated with a value that indicates a percentage of matching of each future skill with the set of current skills. In an example, each future skill, such as ‘Big Data’ and ‘Python’ are associated with values ‘80’ and ‘65’, respectively, indicating that ‘Big Data’ has 80 percent relevancy and ‘Python’ has 65 percent relevancy with the set of current skills of the user 102a, such as ‘Statistics’ and ‘Data Visualization’.

The prediction circuitry 216 may be further configured to determine a weightage of each future skill of the set of future skills based on a demand for each future skill in the organization. The weightage of each future skill is a numerical value of a relative importance of each future skill in the organization. The demand for each future skill is a requirement of a corresponding future skill by the organization to adapt to emerging technologies and achieve digital transformation. In an embodiment, the demand for each future skill is determined based on job profiles of the users 102 and requirement of the respective skills in the organization. In an example, ‘Python’ as a skill is relatively more important for the organization than ‘Big Data’ as a number of projects requiring ‘Python’ as a skill are more compared to ‘Big Data’. Thus, in the example, the prediction circuitry 216 determines the weightage of the set of future skills, such as ‘Big Data’ and ‘Python’, as ‘0.4’ and ‘0.6’, respectively. It will be understood by those of skill in the art that the prediction circuitry 216 may be configured to determine a weightage of each current skill of the set of current skills in a manner similar to the determination of the weightage of each future skill.

The recommendation circuitry 218 may include suitable logic, circuitry, interfaces, and/or code, executable by the circuitry, that may be configured to perform the one or more operations for recommending training plans for the users 102. Based on the learning rate and the set of future skills of each user of the users 102, the recommendation circuitry 218 may be configured to recommend a training plan for each user of the users 102. The training plan includes a set of training courses for the predicted set of future skills and a schedule for each training course. In an example, the recommendation circuitry 218 recommends the set of training courses, such as ‘Introduction to Big Data’ and ‘Python Programming’, for the predicted set of future skills, such as ‘Big Data’ and ‘Python’, respectively. The user 102a is required to complete the set of training courses by way of corresponding online learning platforms. The set of training courses may include audio lectures, video lectures, assessment tests, assignments, and the like. The schedule for each training course may include a start date of the training course, an end date of the training course, and a duration of the training course. In an example, a schedule for a training course, such as ‘Introduction to Big Data’, includes a start date as Sep. 20, 2019′, an end date as Sep. 21, 2019′, and a duration as ‘5 hours’. In an embodiment, the schedule for each training course is determined based on the predicted skill gap, the predicted learning rate, a duration of each training course, and a number of hours dedicated by the corresponding user. In an example, if the predicted learning rates for the user 102a and the user 102b are ‘medium’ and ‘low’, the schedule for the training course may include durations for the training course as ‘5 hours’ and ‘8 hours’ for the user 102a and the user 102b, respectively. Similarly, the predicted skill gap, the duration of each training course, and the number of hours dedicated by the corresponding user may determine the schedule for each training course.

The assessment circuitry 220 may include suitable logic, circuitry, interfaces, and/or code, executable by the circuitry, that may be configured to perform the one or more operations for assessing the training plans of the users 102. The assessment circuitry 220 may be configured to assess the training plan of each user of the users 102 periodically. In an embodiment, the assessment circuitry 220 may be further configured to determine a percentage completion of the set of training courses of the training plan by the corresponding user. The assessment circuitry 220 may be further configured to determine a third score for each user of the users 102 based on the assessment of the training plan of each user of the users 102 periodically. The third score is associated with the percentage completion of a corresponding training plan. In an example, the assessment circuitry 220 determines a percentage completion of the training course, such as ‘Introduction to Big Data’, as ‘80’, and determines the third score as ‘0.8’ for the user 102a.

The assessment circuitry 220 may be configured to determine a number of users of the users 102 associated with each future skill. Based on the third score and the number of users associated with each future skill, the assessment circuitry 220 may be further configured to determine a fourth score for each future skill using the equation (1) given below:

Sₖ=Σᵢ₌₁ⁿCᵢPᵢ (1)

where:
Sk is the fourth score for each skill;
k is a corresponding skill;
Ci is the percentage completion of the training plan, i.e., a third score; and
Pi is each user of the users 102.

In an example, the assessment circuitry 220 determines a number of users that are recommended ‘Introduction to Big Data’ as a training course in the training plan as ‘4’, and determines the fourth score for the corresponding future skill, i.e., ‘Big Data’ using the equation (1) as ‘2.89’. In an embodiment, the training plan of each user of the users 102 is assessed in real-time. In another embodiment, the training plan of each user of the users 102 is assessed at predefined time intervals, such as weekly, monthly, yearly, or the like.

The quantification circuitry 212 is further configured to determine the second score for the organization based on the fourth score for each future skill and the weightage of each future skill. In an embodiment, the quantification circuitry 212 determines the second score using the equation (2) given below:

DTₚ=(Σₖ₌₁^{s}Sₖwₖ)/(Σₖ₌₁^{s}wₖ) (2)

where:
DTP is the second score for the organization;
Sk is the fourth score for each skill;
k is a corresponding skill; and
wk is a weightage of each skill.

The second score is determined in real-time or at the predefined time intervals. In an embodiment, the second score is a normalized score and has a value between ‘0’ and ‘1’. Based on the second score, the classification circuitry 214 may be configured to classify the organization into the second level of digital awareness of the plurality of levels of digital awareness. In an embodiment, if the second score is greater than ‘0’ and less than ‘0.1’, the second level of digital awareness is a digitally nascent level, and if the second score is greater than or equal to ‘0.1’ and less than ‘0.4’, the second level of digital awareness is a digitally informed level. If the second score is greater than or equal to ‘0.4’ and less than ‘0.7’, the second level of digital awareness is a digitally competent level, and if the second score is greater than or equal to ‘0.7’ and less than or equal to ‘1’, the second level of digital awareness is a digitally proficient level. In an example, the second score for the organization is determined using the equation (2) as ‘0.8’, the classification circuitry 214 classifies the organization into the second digital level, i.e., the digitally proficient level. It will be understood by those of skill in the art that the classification circuitry 214 may classify each user of the users 102 into one of the levels of digital awareness based on the assessment of the training plan for the corresponding user, the future skills acquired by the corresponding user, and a value of each of the six metrics C1-C6 for the corresponding user, in a manner similar to the classification of the organization.

The tracker circuitry 222 may include suitable logic, circuitry, interfaces, and/or code, executable by the circuitry, that may be configured to perform the one or more operations for tracking the workforce transformation of the organization. In an embodiment, the tracker circuitry 222 may be configured to track the workforce transformation of the organization periodically based on the first and second levels of digital awareness. The tracker circuitry 222 may track the workforce transformation of the organization by analyzing the transformation of the organization from the first level of digital awareness to the second level of digital awareness. In an example, the tracker circuitry 222 tracks the transformation of the organization from the digitally competent level to the digitally proficient level. Thus, the tracker circuitry 222 determines that the workforce of the organization accelerates from the digitally competent level to the digitally proficient level to achieve desired business outcomes, such as improvement in current technologies and processes within the organization, improvement in the current status of digital awareness of the organization, and the like. Further, the workforce transformation is quantified based on the first and second scores of the organization.

It will be understood by those of skill in the art that in one exemplary scenario the first and second levels of digital awareness are same, such as the digitally competent level, if the first and second scores determined by the quantification circuitry 212 are ‘0.5’ and ‘0.65’, respectively. It will be apparent to a person of ordinary skill in the art that the scope of the disclosure is not limited to the application server 106 to include only the quantification circuitry 212, the classification circuitry 214, the prediction circuitry 216, the recommendation circuitry 218, the assessment circuitry 220, and the tracker circuitry 222, for controlling and managing various functionalities and operations of the application server 106. In another embodiment, the application server 106 may include different circuitries for controlling and managing various functionalities and operations of the application server 106 without deviating from the scope of the disclosure.

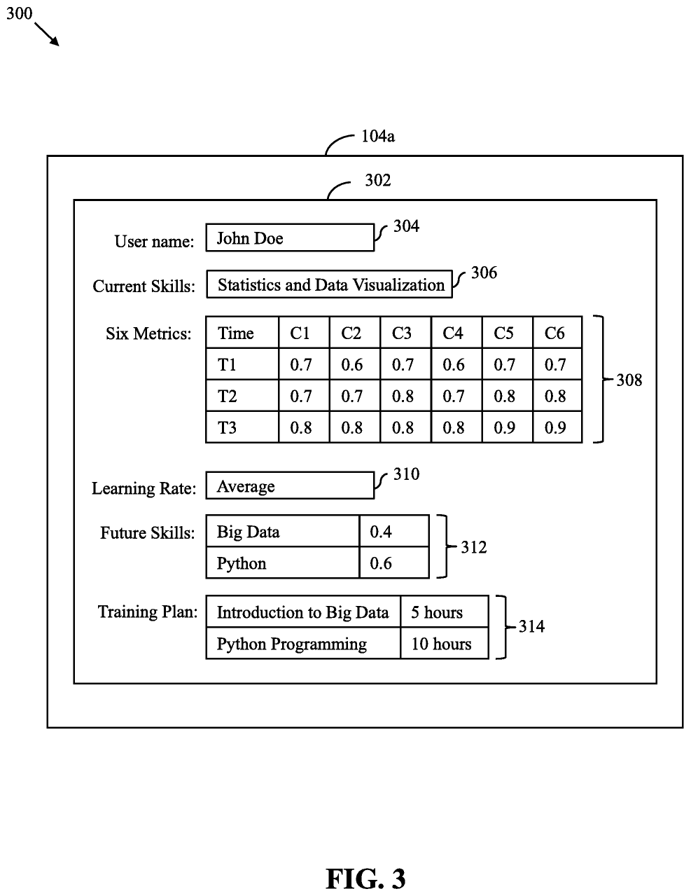

FIG. 3 is a block diagram 300 that illustrates a first user interface 302 rendered on the user device 104a, in accordance with an embodiment of the disclosure. The application server 106 may be configured to render the first user interface 302 on the user device 104a.

The first user interface 302 may include a first text box 304, where a user name (for example, “John Doe”) of the user 102a is displayed. The quantification circuitry 212 extracts data associated with the user 102a. The quantification circuitry 212 processes the data to determine a set of current skills (for example, “Statistics” and “Data Visualization”) for the user 102a. The first user interface 302 may include a second text box 306, where the set of current skills (i.e., “Statistics” and “Data Visualization”) of the user 102a are displayed. The first user interface 302 may include a third text box 308, where the values of the six metrics C1-C6 at different time instances for the user 102a are displayed. For example, at time instance “T1” the values of the six metrics C1-C6 are “0.7”, “0.6”, “0.7”, “0.6”, “0.7”, and “0.7”, respectively, at time instance “T2” the values of the six metrics C1-C6 are “0.7”, “0.7”, “0.8”, “0.7”, “0.8”, and “0.8”, respectively, and at time instance “T3” the values of the six metrics C1-C6 are “0.8”, “0.8”, “0.8”, “0.8”, “0.9”, and “0.9”, respectively. The first user interface 302 may include a fourth text box 310, where the learning rate (for example, “average”) of the user 102a is displayed.

The first user interface 302 may include a fifth text box 312, where the set of future skills (for example, “Big Data” and “Python”) that is predicted by the prediction circuitry 216 for the user 102a are displayed. The prediction circuitry 216 determines a weightage (for example, “0.4” and “0.6”) associated with each future skill. Based on the set of future skills of the user 102a, the recommendation circuitry 218 recommends a training plan for the user 102a to acquire the set of future skills predicted for the user 102a. The first user interface 302 may include a sixth text box 314, where the training plan recommended by the recommendation circuitry 218 for the user 102a is displayed. The training plan includes a set of training courses (for example, “Introduction to Big Data” and “Python Programming”) along with a number of hours (for example, “5 hours” and “10 hours”) required for completing the set of training courses. In an embodiment, the set of training courses displayed in the sixth text box 314 are associated with corresponding universal resource locators (URLs) of online learning platforms. The URLs of the set of training courses may be selected by the user 102a by utilizing the user device 104a to navigate to the respective online learning platform for learning the respective training course.

It will be apparent to a person of ordinary skill in the art that the scope of the disclosure is not limited to the first user interface 302 to include only the first through sixth text boxes 304-314. In another embodiment, the first user interface 302 may include any number of text boxes without deviating from the scope of the disclosure. It will be understood by those of skill in the art that the application server 106 renders a user interface on the user devices 104b-104n of the users 102b-102n, respectively, in a manner similar to rendering of the first user interface 302 on the user device 104a.

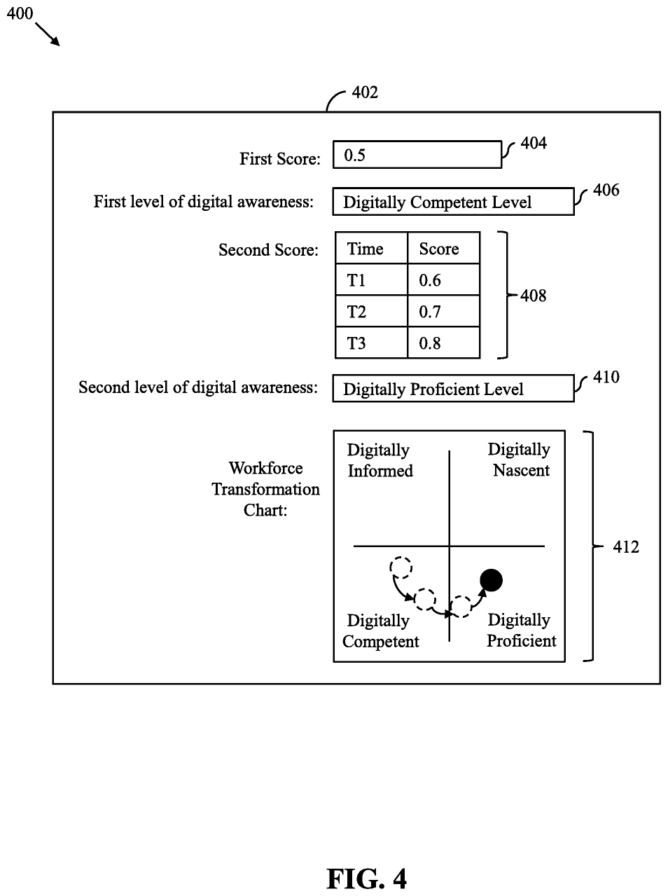

FIG. 4 is a block diagram 400 that illustrates a second user interface 402 rendered on a display screen (not shown) associated with the application server 106, in accordance with an embodiment of the disclosure. The application server 106 may be configured to render the second user interface 402 on the display screen by way of the I/O port 208.

The quantification circuitry 212 determines the first score for the organization based on the six metrics C1-C6 of each user and the set of current skills of each user. The second user interface 402 may include a seventh text box 404, where the first score (for example, “0.5”) of the organization is displayed. The classification circuitry 214 classifies the organization into the first level of digital awareness based on the first score. The second user interface 402 may include an eighth text box 406, where the first level of digital awareness (for example, “Digitally Competent Level”) of the organization is displayed.

The quantification circuitry 212 determines the second score for the organization based on the fourth score for each future skill and the weightage of each future skill. The second user interface 402 may include a ninth text box 408, where the second score at different time instances of the organization is displayed. For example, at time instance “T1” the second score is “0.6”, at time instance “T2” the second score is “0.7”, and at time instance “T3” the second score is “0.8”. The classification circuitry 214 classifies the organization into the second level of digital awareness based on the second score (for example, the second score at time instance “T3”). The second user interface 402 may include a tenth text box 410, where the second level of digital awareness (for example, “Digitally Proficient Level”) of the organization is displayed. The tracker circuitry 222 may be configured to track the workforce transformation of the organization periodically (for example, at time instances “T1-T3”) based on the first and second levels of digital awareness. The second user interface 402 may include a workforce transformation chart 412, where the transformation of the workforce from the first level of digital awareness (for example, “Digitally Competent Level”) to the second level of digital awareness (for example, “Digitally Proficient Level”) is displayed.

It will be apparent to a person of ordinary skill in the art that the scope of the disclosure is not limited to the second user interface 402 to include only the seventh through tenth text boxes 404-410 and the workforce transformation chart 412. In another embodiment, the second user interface 402 may include any number of text boxes and any number of charts without deviating from the scope of the disclosure. It will be understood to those of skill in the art that the application server 106 may render the first user interface 302 and the user interfaces rendered on the user devices 104b-104n, on the display screen associated with the application server 106.

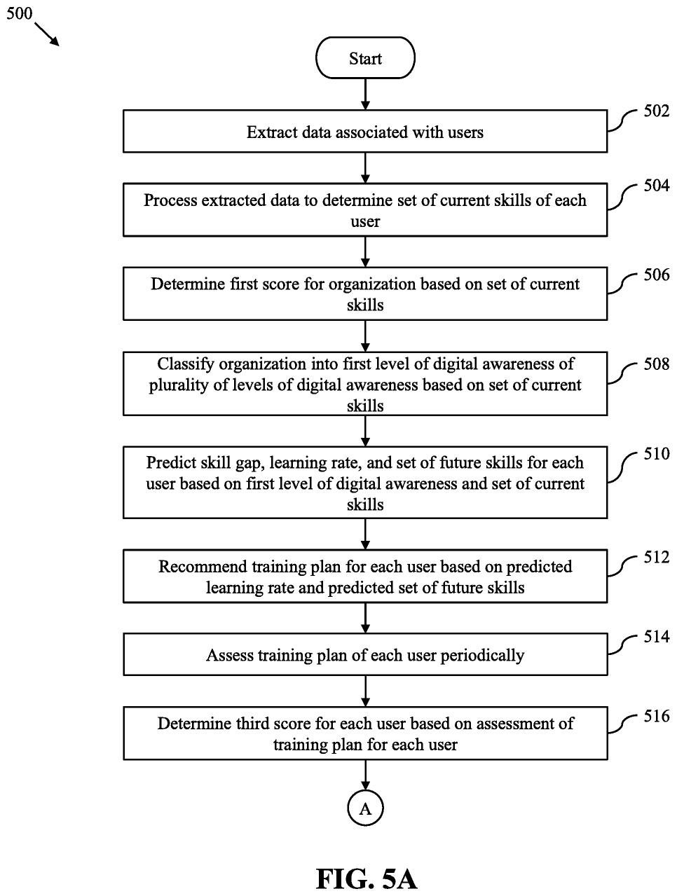

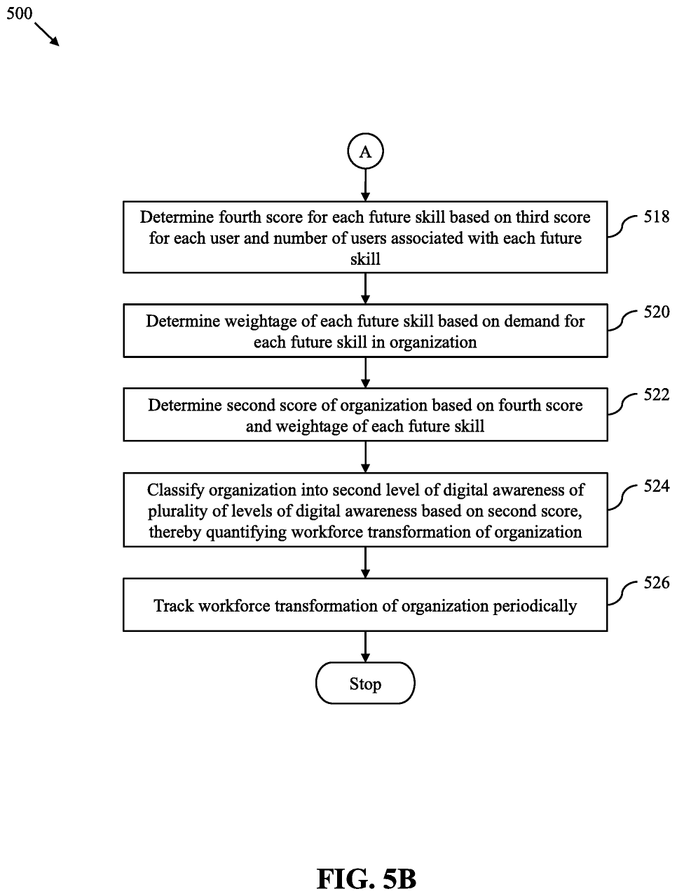

FIGS. 5A and 5B, collectively, represent a flow chart 500 that illustrates a method for quantifying the workforce transformation of the organization in accordance with an embodiment of the disclosure.

At step 502, the application server 106 extracts the data associated with the users 102 from at least the set of documents, the set of skill profiles, the set of accomplished trainings, and the set of certifications that are associated with the users 102. At step 504, the application server 106 processes the extracted data associated with the users 102, to determine the set of current skills of each user of the users 102. At step 506, the application server 106 determines based on the set of current skills associated with each user of the users 102, the first score for the organization.

At step 508, the application server 106 classifies based on the first score, the organization into the first level of digital awareness of the plurality of levels of digital awareness. At step 510, the application server 106 predicts based on the first level of digital awareness and the set of current skills, the skill gap, the learning rate, and the set of future skills for each user of the users 102.

At step 512, the application server 106 recommends based on the predicted learning rate and the predicted set of future skills, the training plan for each user of the users 102. At step 514, the application server 106 assesses the training plan of each user of the users 102 periodically, to determine the second score for the organization. At step 516, the application server 106 determines based on the assessment of the training plan for each user of the users 102 periodically, the third score for each user of the users 102. The third score is associated with the percentage completion of a corresponding training plan by each user of the users 102.

At step 518, the application server 106 determines based on the third score for each user of the users 102 and the number of individuals associated with each future skill, the fourth score for each future skill. At step 520, the application server 106 determines based on the demand for the corresponding future skill in the organization, the weightage of each future skill. The weightage of each future skill is a numerical value of a relative importance of each future skill in the organization. At step 522, the application server 106 determines based on the fourth score and the weightage of each future skill, the second score for the organization.

At step 524, the application server 106 classifies based on the second score, the organization into the second level of digital awareness of the plurality of levels of digital awareness, thereby quantifying the workforce transformation of the organization. At step 526, the application server 106 tracks based on the first and second levels of digital awareness, the workforce transformation of the organization periodically.

The application server 106 determines the six metrics C1-C6 for each user of the users 102, to classify each user into one of the plurality of digital awareness levels. The application server 106 determines the first and second scores for the organization and classifies the organization into the first and second levels of digital awareness, respectively. Thus, the application server 106 utilizes the six metrics C1-C6 and the first and second scores to quantify the workforce transformation of the organization. Additionally, the application server 106 tracks the movement of the organization from the first level of digital awareness to the second level of digital awareness by way of the tracker circuitry 222. Thus, the application server 106 keeps a track of the current status of digital awareness of the organization and predicts roadmaps for further transforming the workforce for achieving desired business outcomes and improving the digital awareness of the organization to adapt the emerging digital technologies and processes within the organization.

While various embodiments of the disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims.

1. A system for quantifying workforce transformation of an organization, the system comprising:
a server that is configured to:
determine based on a set of current skills associated with each individual of a set of individuals of the organization, a first score for the organization;
classify based on the first score, the organization into a first level of digital awareness of a plurality of levels of digital awareness;
predict based on the first level of digital awareness and the set of current skills, a skill gap, a learning rate, and a set of future skills for each individual;
recommend based on the predicted learning rate and the predicted set of future skills, a training plan for each individual;
assess the training plan of each individual periodically, to determine a second score for the organization; and
classify based on the second score, the organization into a second level of digital awareness of the plurality of levels of digital awareness, thereby quantifying the workforce transformation of the organization.

2. The system of claim 1, wherein the plurality of levels of digital awareness include a digitally nascent level, a digitally informed level, a digitally competent level, and a digitally proficient level.

3. The system of claim 1, wherein the server is further configured to:
extract data associated with the set of individuals from at least a set of documents, a set of skill profiles, a set of accomplished trainings, and a set of certifications that are associated with the set of individuals; and
process the data associated with the set of individuals, to determine the set of current skills of each individual.

4. The system of claim 1, wherein the server is further configured to:
track based on the first and second levels of digital awareness, the workforce transformation of the organization periodically.

5. The system of claim 1, wherein the server is further configured to:
determine based on the assessment of the training plan for each individual periodically, a third score for each individual, wherein the third score is associated with a percentage completion of a corresponding training plan by each individual; and
determine based on the third score for each individual and a number of individuals associated with each future skill, a fourth score for each future skill.

6. The system of claim 5, wherein the server is further configured to:
determine based on a demand for each future skill in the organization, a weightage of each future skill, wherein the weightage of each future skill is a numerical value of a relative importance of each future skill in the organization.

7. The system of claim 6, wherein the second score is determined based on the fourth score and the weightage of each future skill, and wherein the first and second scores are normalized scores.

8. The system of claim 1, wherein each future skill is associated with a value that indicates a percentage of matching of each future skill with the set of current skills.

9. The system of claim 1, wherein the training plan of each individual is assessed in real-time, and wherein the second score for the organization is determined in real-time.

10. The system of claim 1, wherein the training plan includes a set of training courses for the predicted set of future skills and a schedule for each training course, and wherein the schedule for each training course is determined based on the predicted skill gap, the predicted learning rate, a duration of each training course, and a number of hours dedicated by a corresponding individual.

11. A method for quantifying workforce transformation of an organization, the method comprising:
determining, by a server based on a set of current skills associated with each individual of a set of individuals of the organization, a first score for the organization;
classifying, by the server based on the first score, the organization into a first level of digital awareness of a plurality of levels of digital awareness;
predicting, by the server based on the first level of digital awareness and the set of current skills, a skill gap, a learning rate, and a set of future skills for each individual;
recommending, by the server based on the predicted learning rate and the predicted set of future skills, a training plan for each individual;
assessing, by the server, the training plan of each individual periodically, to determine a second score for the organization; and
classifying, by the server based on the second score, the organization into a second level of digital awareness of the plurality of levels of digital awareness, thereby quantifying the workforce transformation of the organization.

12. The method of claim 11, wherein the plurality of levels of digital awareness include a digitally nascent level, a digitally informed level, a digitally competent level, and a digitally proficient level.

13. The method of claim 11, further comprising:
extracting, by the server, data associated with the set of individuals from at least a set of documents, a set of skill profiles, a set of accomplished trainings, and a set of certifications that are associated with the set of individuals; and
processing, by the server, the data associated with the set of individuals, to determine the set of current skills of each individual.

14. The method of claim 11, further comprising:
tracking, by the server based on the first and second levels of digital awareness, the workforce transformation of the organization periodically.

15. The method of claim 11, further comprising:
determining, by the server based on the assessment of the training plan for each individual periodically, a third score for each individual, wherein the third score is associated with a percentage completion of a corresponding training plan by each individual; and
determining, by the server based on the third score for each individual and a number of individuals associated with each future skill, a fourth score for each future skill.

16. The method of claim 15, further comprising:
determining, by the server based on a demand for each future skill in the organization, a weightage of each future skill, wherein the weightage of each future skill is a numerical value of a relative importance of each future skill in the organization.

17. The method of claim 16, wherein the second score is determined based on the fourth score and the weightage of each future skill, and wherein the first and second scores are normalized scores.

18. The method of claim 11, wherein each future skill is associated with a value that indicates a percentage of matching of each future skill with the set of current skills.

19. The method of claim 11, wherein the training plan of each individual is assessed in real-time, and wherein the second score for the organization is determined in real-time.

20. The method of claim 11, wherein the training plan includes a set of training courses for the predicted set of future skills and a schedule for each training course, and wherein the schedule for each training course is determined based on the predicted skill gap, the predicted learning rate, a duration of each training course, and a number of hours dedicated by a corresponding individual.
